(19) United States
(12) Patent Application Publication
(10) Pub. No.: US 2007/0159462 A1
(43) Pub. Date: Jul. 12, 2007

(54) INPUT DEVICE WITH TILTABLE SCROLL WHEEL MODULE

(75) Inventors: Hong-Che Yen, Taipei (TW); Hsiao-Lung Chiang, Taipei (TW); Bing-Jhang Tu, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Primax Electronics Ltd., Taipei (TW)

(21) Appl. No.: 11/422,292

(22) Filed: Jun. 5, 2006

(30) Foreign Application Priority Data
Jan. 10, 2006 (TW) 095100875

(51) Int. Cl. G09G 5/08

(52) U.S. Cl. 345/163

(57) ABSTRACT

A tiltable scroll wheel module for use in an input device is provided. Two confining members with complementary shapes are arranged inside the tiltable scroll wheel module. When the scroll wheel is pressed down, these two confining members are engaged with each other. Under this circumstance, the carrier member is confined in position without largely swinging the carrier member toward the left or right side thereof.

### FIELD OF THE INVENTION

The present invention relates to an input device communicable with a computer system, and more particularly to an input device with a tiltable scroll wheel module.

### BACKGROUND OF THE INVENTION

An input device such as a mouse or a keyboard has been widely employed in a computer system for scrolling images shown on the display screen upwardly and downwardly. For example, by rotating a scroll wheel of such an input device forwardly or backwardly, a specified control signal is generated to control the scrolling operations of web pages. In addition to the vertical scroll movement, it is important to achieve the horizontal scroll movement. For example, since the texts or graphs shown in the graphic-based window of the display screen usually fail to be fully browsed, the horizontal scroll movement is required to move the web page or the document in the left or right direction so as to display the desired image as required.

For facilitating a user to perform the horizontal scroll movement of the web pages shown on the display screen by operating the scroll wheel, a tiltable scroll wheel module capable of being tilted leftwards or rightwards is developed. Such tiltable scroll wheel module is applicable to an input device such as a mouse or a keyboard. Referring to FIG. 1A, a schematic outside view of a mouse having a tiltable scroll wheel module is illustrated. The tiltable scroll wheel module 11 of the mouse 1 is positioned within an opening 101 of the main body 10 of the mouse 1, and a portion of the scroll wheel 12 is protruded from the outer surface of the main body 10 such that the tiltable scroll wheel module 11 can be manipulated by a user. The scroll wheel 12 of the tiltable scroll wheel module 11 can be rotated forwardly (as shown in the arrow F) or backwardly (as shown in the arrow B) to generate a control signal, thereby scrolling the image shown on the display screen upwardly and downwardly. Furthermore, the scroll wheel 12 can be pressed down (as shown in the arrow D), tilted toward the left side (as shown in the arrow L) or tilted toward the right side (as shown in the arrow R) so as to generate three other control signals.

Referring to FIG. 1B, a schematic perspective view of a tiltable scroll wheel module is illustrated. The tiltable scroll wheel module 11 principally comprises a scroll wheel 12, a rotating shaft 13, a carrier member 14 and a supporting member 15. The supporting member 15 has a receptacle 151 at the top side thereof. In addition, three switch units 16A, 16B and 16C are arranged under the bilateral sides of the carrier member 14 and under the rear end of the carrier member 14, respectively. The rotating shaft 13 is supported on a notch structure 141 of the carrier member 14, so that the scroll wheel 12 is rotatable along the rotating shaft 13.

Please refer to FIG. 1B again. The tiltable scroll wheel module 11 further comprises lateral wing structures 142A and 142B at bilateral sides of the carrier member 14 and above the switch units 16A and 16B, respectively. In addition, the front and rear ends of the carrier member 14 are formed as protrusion rods 143A and 143B. The protrusion rod 143A is movably supported on the receptacle 151 of the supporting member 15. Whereas, the protrusion rod 143B is placed on the top surface of the switch unit 16C. In a case that the scroll wheel 12 is tilted toward the left or right side, the receptacle 151 of the supporting member 15 and the top surface of the switch unit 16C are used as the fulcrum portions such that the carrier member 14 is movable in the left or right direction. Meanwhile, the lateral wing structure 142A or 142B will touch and trigger the switch unit 16A or 16B. In addition, in a case that the scroll wheel 12 is pressed down, the receptacle 151 of the supporting member 15 is served as the fulcrum portion such that the protrusion rod 143B is moved downwardly to trigger the switch unit 16C.

Please refer to FIG. 1C, which is a schematic side view of the tiltable scroll wheel module of FIG. 1B taken from a viewpoint in the direction RV1. As shown in FIG. 1C, in the case that the scroll wheel 12 is not enabled, the protrusion rod 143B of the carrier member 14 is slightly in contact with the top surface of the switch unit 16C but the switch unit 16C is not triggered. Referring to FIG. 1D, in a case that the scroll wheel 12 is pressed down, the switch unit 16C may be triggered by the protrusion rod 143B of the carrier member 14. Unfortunately, the depressing force applied onto the scroll wheel 12 is likely to improperly swing toward the left or right side if the hand of the user is slippery hand or the depressing angle is shifted. Under this circumstance, the lateral wing structure 142A or 142B is likely to touch and trigger the switch unit 16A or 16B. As shown in FIG. 1E, the switch units 16C and 16A are simultaneously triggered by the protrusion rod 143B of the carrier member 14 and the lateral wing structure 142A. Likewise, the switch units 16C and 16A may be simultaneously triggered by the protrusion rod 143B of the carrier member 14 and the lateral wing structure 142B. Meanwhile, the mouse 1 is suffered from an erroneous operation, for example interruption of a current control signal or generation of an unanticipated control signal.

In views of the above-described disadvantages resulted from the prior art, the applicant keeps on carving unflaggingly to develop an input device with a tiltable scroll wheel module according to the present invention through wholehearted experience and research.

### SUMMARY OF THE INVENTION

As previously described, the depressing force applied onto the scroll wheel is likely to improperly swing toward the left or right side if the hand of the user is slippery hand or the depressing angle is shifted. Under this circumstance, two switch units are simultaneously triggered and the input device is suffered from an erroneous operation, for example interruption of a current control signal or generation of an unanticipated control signal.

It is an object of the present invention to provide an input device with a tiltable scroll wheel module for avoiding erroneous operation of the scroll wheel caused from simultaneous triggering of two switch units. This object is achieved by confining the carrier member in position so as to avoid improperly swinging the carrier member toward the left or right side.

In accordance to an aspect of the present invention, there is provided an input device with a tiltable scroll wheel module. The tiltable scroll wheel module comprises a scroll wheel, a carrier member for supporting the scroll wheel, a switch unit disposed below the carrier member and a first confining member disposed on the carrier member. In addition, the first confining member is kept at least a certain clearance from a second confining member thereunder. When the scroll wheel is pressed down, the switch unit is triggered by the carrier member and the first confining member is engaged with the second confining member. Therefore, the carrier member is confined in position without largely swinging the carrier member toward the left or right side thereof. Until the depressing force applied onto the scroll wheel is eliminated, the first confining member is disengaged from the second confining member, so that the carrier member can be tilted toward the left or right side as required.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic outside view of a mouse having a tiltable scroll wheel module according to prior art;

FIG. 1B is a schematic perspective view of the tiltable scroll wheel module of the mouse in FIG. 1A;

FIG. 1C is a schematic side view of the tiltable scroll wheel module shown in FIG. 1B taken from a viewpoint in the direction RV1, wherein the tiltable scroll wheel module has not been enabled;

FIG. 1D is a schematic side view of the tiltable scroll wheel module of FIG. 1B taken from a viewpoint in the direction RV1, wherein a switch unit is triggered when the scroll wheel is pressed down;

FIG. 1E is a schematic side view of the tiltable scroll wheel module of FIG. 1B taken from a viewpoint in the direction RV1, wherein two switch unit are simultaneously triggered when the scroll wheel is pressed down;

FIG. 2A is a schematic perspective view of a tiltable scroll wheel module of a mouse according to a first preferred embodiment of the present invention;

FIG. 2B is a schematic perspective view of the tiltable scroll wheel module of FIG. 2A taken from another viewpoint;

FIG. 2C is a schematic side view of the tiltable scroll wheel module shown in FIG. 2B taken from a viewpoint in the direction RV2, wherein the tiltable scroll wheel module has not been enabled;

FIG. 2D is a schematic side view of the tiltable scroll wheel module shown in FIG. 2B taken from a viewpoint in the direction RV2, wherein a switch unit is triggered when the scroll wheel is tilted toward the left side;

FIG. 2E is a schematic side view of the tiltable scroll wheel module shown in FIG. 2B taken from a viewpoint in the direction RV2, wherein another switch unit is triggered when the scroll wheel is pressed down;

FIGS. 2F-2K are schematic side views illustrating some variants of two confining members of the tiltable scroll wheel module according to the present invention;

FIG. 3A is a schematic perspective view of a tiltable scroll wheel module of a mouse according to a second preferred embodiment of the present invention;

FIG. 3B is a schematic side view of the tiltable scroll wheel module shown in FIG. 3A taken from a viewpoint in the direction RV3, wherein the tiltable scroll wheel module has not been enabled;

FIG. 3C is a schematic side view of the tiltable scroll wheel module shown in FIG. 3A taken from a viewpoint in the direction RV3, wherein a switch unit is triggered when the scroll wheel is tilted toward the left side;

FIG. 3D is a schematic side view of the tiltable scroll wheel module shown in FIG. 3A taken from a viewpoint in the direction RV3, wherein another switch unit is triggered when the scroll wheel is pressed down; and

FIGS. 3E-3I are schematic side views illustrating some variants of two confining members of the tiltable scroll wheel module according to the present invention.

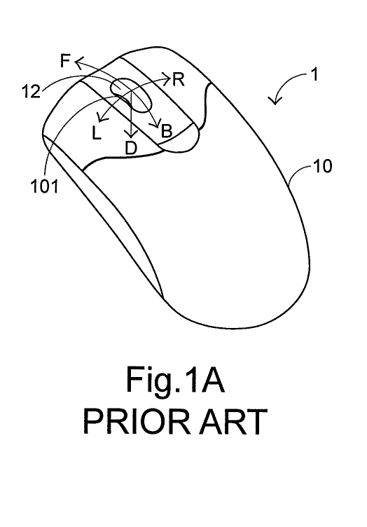

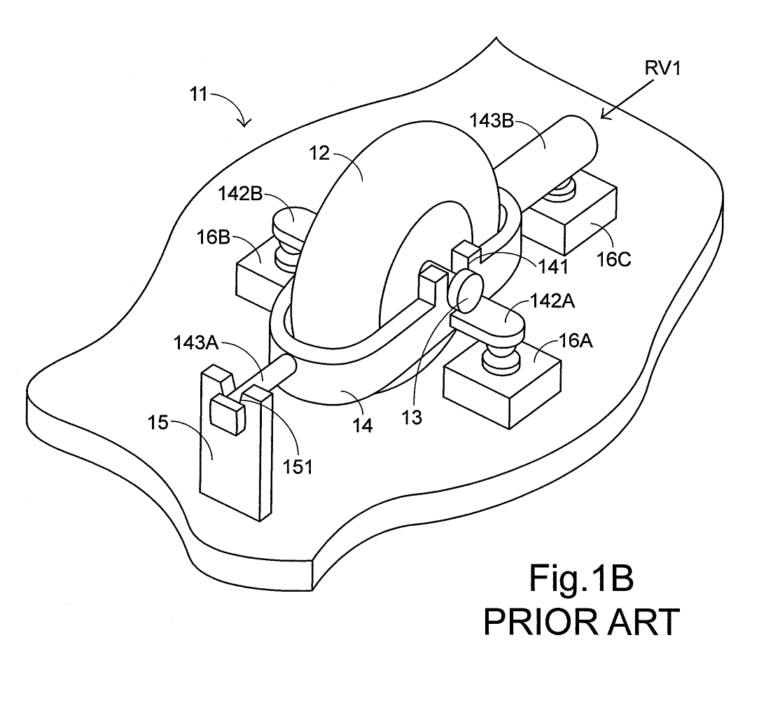

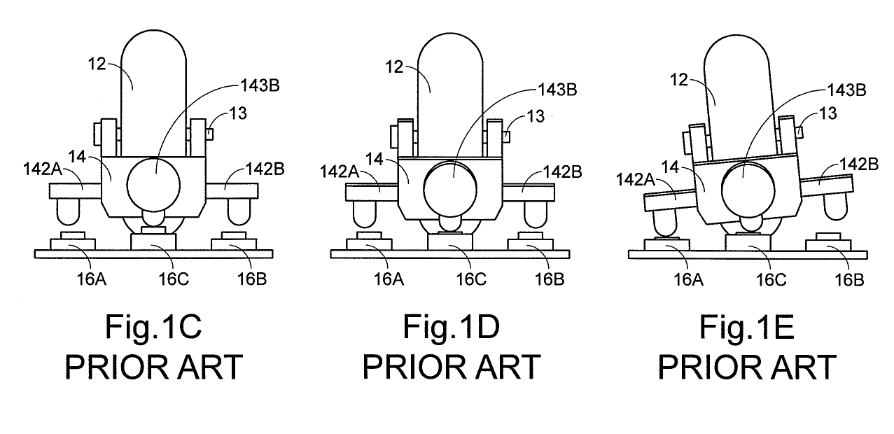

### DETAILED DESCRIPTION OF THE PREFERRED EMBODIMENT

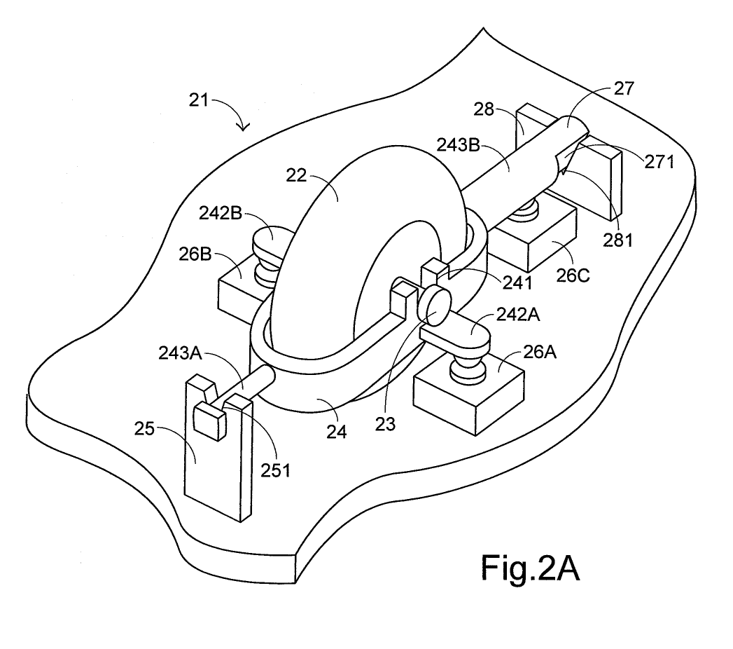

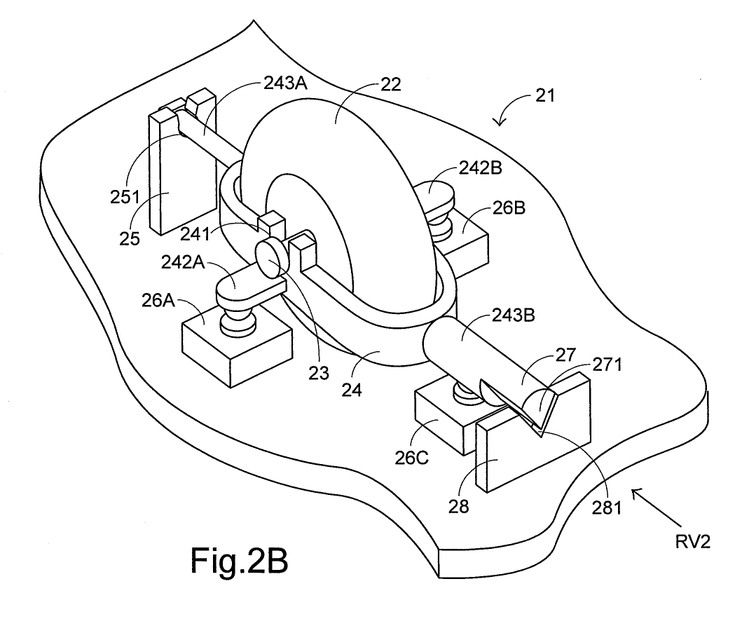

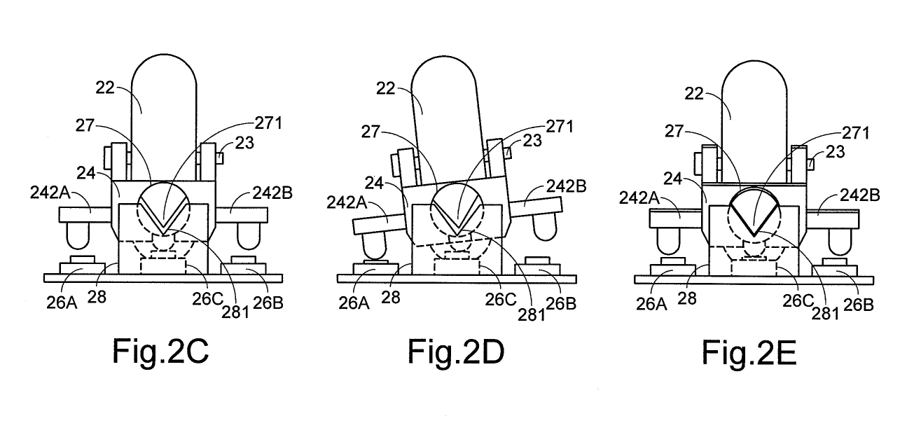

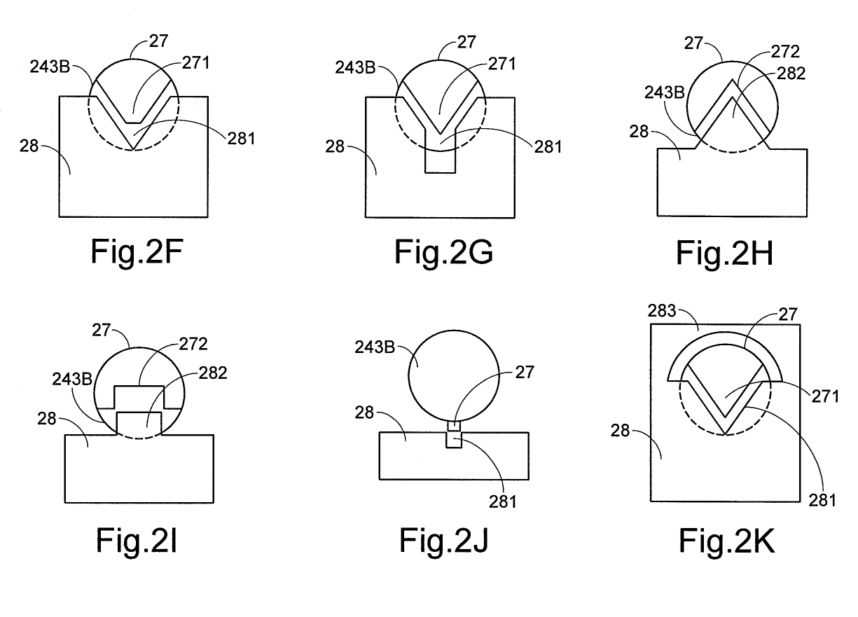

Referring to FIG. 2A, a tiltable scroll wheel module for use in an input device according to a first preferred embodiment of the present invention is illustrated. Please also refer to FIG. 2B, which is a schematic perspective view of FIG. 2A taken from another viewpoint.

The tiltable scroll wheel module 21 as shown in FIGS. 2A and 2B is applicable to an input device such as a mouse or a keyboard. Likewise, a portion of the tiltable scroll wheel module 21 is protruded from the outer surface of the main body of the input device, so that the tiltable scroll wheel module 21 can be manipulated by a user. The tiltable scroll wheel module 21 of the present invention principally comprises a scroll wheel 22, a rotating shaft 23, a carrier member 24 and a supporting member 25. The supporting member 25 has a receptacle 251 at the top side thereof. In addition, three switch units 26A, 26B and 26C are arranged under the bilateral sides of the carrier member 24 and under the rear end of the carrier member 24, respectively. The rotating shaft 23 is supported on a notch structure 241 of the carrier member 24, so that the scroll wheel 22 is rotatable along the rotating shaft 23.

Please refer to FIGS. 2A and 2B again. The tiltable scroll wheel module 21 further comprises lateral wing structures 242A and 242B at bilateral sides of the carrier member 24 and above the switch units 26A and 26B, respectively. In addition, the front and rear ends of the carrier member 24 are formed as protrusion rods 243A and 243B. The protrusion rod 243A is movably supported on the receptacle 251 of the supporting member 25. Whereas, the protrusion rod 243B is placed on the top surface of the switch unit 26C. When the scroll wheel 22 is tilted toward the left or right side, the receptacle 251 of the supporting member 25 and the top surface of the switch unit 26C are used as the fulcrum portions such that the carrier member 24 will swing leftwards or rightwards. Meanwhile, the lateral wing structure 242A or 242B will touch and trigger the switch unit 26A or 26B. In addition, if the scroll wheel 22 is pressed down, the receptacle 251 of the supporting member 25 is served as the fulcrum portion such that the protrusion rod 243B is moved downwardly to trigger the switch unit 26C.

Please refer to FIGS. 2A and 2B again. For a purpose of avoiding improperly swinging the carrier member toward the left or right side or otherwise allowing for tiny swing of the scroll wheel 22 when the scroll wheel 22 is pressed down to trigger the switch unit 26C, the tiltable scroll wheel module 21 further comprises two confining members 27 and 28 for confining the carrier member 24 in position. The confining members 27 and 28 have complementary shapes. Due to the complementary shapes, the confining member 27 is shifted downwardly to be engaged with the confining member 28 while the scroll wheel 22 is pressed down to trigger the switch unit 26C. Therefore, the carrier member 24 is confined in position so as to avoid improperly swinging the carrier member 24 toward the left or right side or otherwise allow for tiny swing of the carrier member 24. Under this circumstance, the lateral wing structure 242A or 242B will no longer trigger the switch unit 26A or 26B while the scroll wheel 22 is pressed down to trigger the switch unit 26C. Until the depressing force applied onto the scroll wheel 22 is eliminated, the scroll wheel 22 is moved upwardly and returns to its original shape due to a restoring force generated from the compressed switch unit 26C. Meanwhile, the confining member 27 is disengaged from the confining member 28, so that the carrier member 24 can be tilted toward the left or right side as required.

Please refer to FIG. 2B again. In the tiltable scroll wheel module 21 of this embodiment, the confining member 27 is formed at the tip portion of the protrusion rod 243B and comprises a convex confining part 271. The confining member 28 has a concave confining part 281 corresponding to the convex confining part 271 of the confining member 27. The convex confining part 271 of the confining member 27 would be engaged with the concave confining part 281 while the scroll wheel 22 is pressed down to trigger the switch unit 26C. Therefore, the carrier member 24 is confined in position so as to avoid improperly swinging the carrier member 24 toward the left or right side or otherwise allow for tiny swing of the carrier member 24. Under this circumstance, the lateral wing structure 242A or 242B will no longer trigger the switch unit 26A or 26B while the scroll wheel 22 is pressed down to trigger the switch unit 26C.

Please refer to FIG. 2C, which is a schematic rear view of FIG. 2B taken from a viewpoint in the direction RV2. As shown in FIG. 2C, in the case that the scroll wheel 22 is not enabled, the protrusion rod 243B of the carrier member 24 is slightly in contact with the top surface of the switch unit 26C but the switch unit 26C is not triggered. In addition, the convex confining part 271 of the confining member 27 is kept at least a certain clearance from the concave confining part 281 of the confining member 28. At that time, if the scroll wheel 22 is tilted toward the left side as shown in FIG. 2D, the convex confining part 271 of the confining member 27 is also tilted toward the left side along with the carrier member 24. Under this circumstance, the switch unit 26A is triggered by the carrier member 24 without being restricted by the confining member 28. Referring to FIG. 2E, the scroll wheel 22 is pressed down, and thus the switch unit 26C is triggered by the protrusion rod 243B of the carrier member 24. Since the convex confining part 271 of the confining member 27 is engaged with the concave confining part 281 of the confining member 28 at this moment, the carrier member 24 would not swing toward the left or right side or the swing of the carrier member 24 is not enough to trigger the switch unit 26C.

Please refer to FIG. 2B again. The convex confining part 271 of the confining member 27 and the concave confining part 281 of the confining member 28 have complementary shapes, so that the confining member 27 may be engaged with the confining member 28. It is noted that, however, those skilled in the art will readily observe that numerous modifications and alterations of the convex confining part 271 or the concave confining part 281 may be made while retaining the teachings of the invention. For example, as shown in FIGS. 2F and 2G, even though the convex confining part 271 and the concave confining part 281 are not completely mated with each other, the carrier member 24 could be confined in position to avoid improperly swinging the carrier member 24 toward the left or right side when the convex confining part 271 is engaged with the concave confining part 281. Accordingly, the above disclosure should be limited only by the bounds of the following claims.

Please refer to FIG. 2B again. The convex confining part 271 and the concave confining part 281 are formed at the confining members 27 and 28 of the carrier member, respectively. Alternatively, as shown in FIGS. 2H and 21, a concave confining part 272 and a convex confining part 282 with complementary shapes are formed at the confining members 27 and 28 of the carrier member, respectively. When the concave confining part 272 is engaged with the convex confining part 282, the carrier member 24 could be confined in position to avoid improperly swing the carrier member 24 toward the left or right side.

Please refer to FIG. 2B again. In the tiltable scroll wheel module 21 of this embodiment, the confining member 27 is formed in the protrusion rod 243B of the carrier member 24. Alternatively, the confining member 27 is additionally arranged on the protrusion rod 243B of the carrier member 24, as is shown in FIG. 2J.

Alternatively, as shown in FIG. 2K, a top cover 283 is extended from the confining member 28 and above the confining member 27 so as to prevent detachment of the confining member 27 from the confining member 28.

A further embodiment of a tiltable scroll wheel module for use in an input device is illustrated. The tiltable scroll wheel module 31 of this embodiment principally comprises a scroll wheel 32, a rotating shaft 33, a carrier member 34 and a supporting member 35. The supporting member 35 has a receptacle 351 at the top side thereof. In addition, three switch units 36A, 36B and 36C are arranged under the bilateral sides of the carrier member 34 and under the rear end of the carrier member 34, respectively. The rotating shaft 33 is supported on a notch structure 341 of the carrier member 34, so that the scroll wheel 32 is rotatable along the rotating shaft 33.

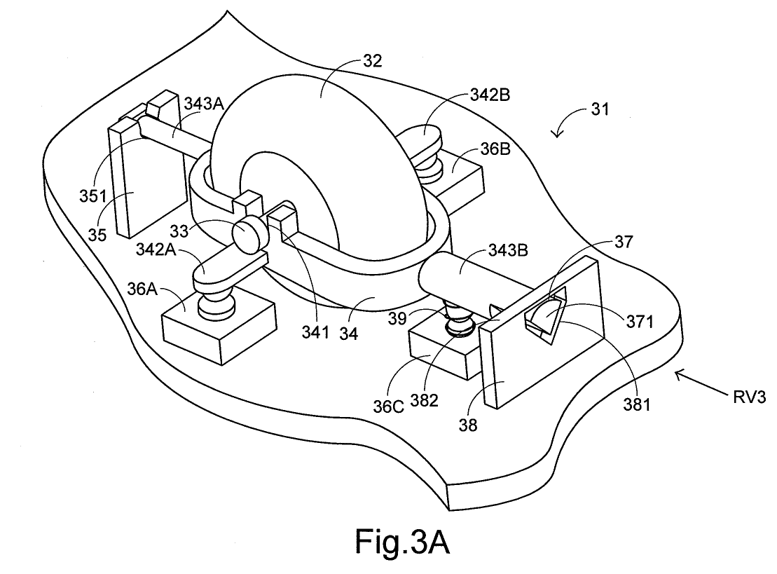

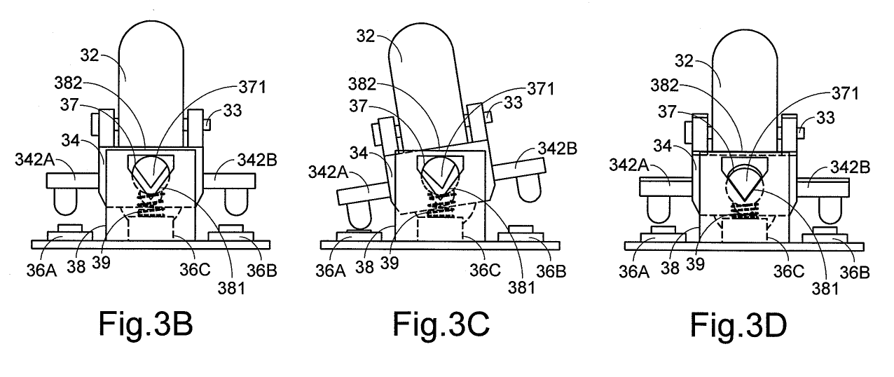

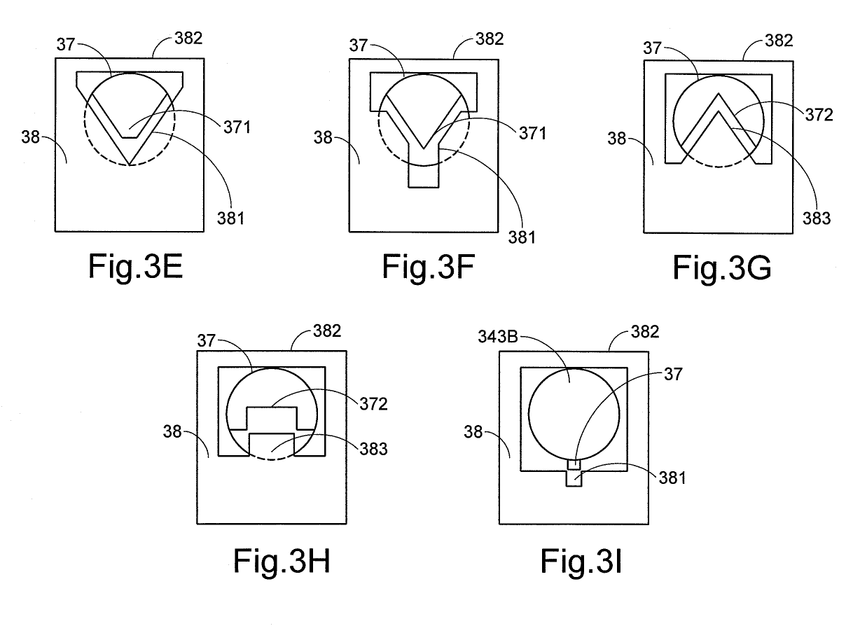

Please refer to FIG. 3A again. The tiltable scroll wheel module 31 further comprises lateral wing structures 342A and 342B at bilateral sides of the carrier member 34 and above the switch units 36A and 36B, respectively. In addition, the front and rear ends of the carrier member 34 are formed as protrusion rods 343A and 343B. The protrusion rod 343A is movably supported on the receptacle 351 of the supporting member 35. Whereas, the protrusion rod 343B is placed on the top surface of the switch unit 36C. In addition, a spring 39 is sustained between the protrusion rod 343B and the switch unit 36C. When the scroll wheel 32 is tilted toward the left or right side, the receptacle 351 of the supporting member 35 and the top surface of the spring 39 are used as the fulcrum portions such that the carrier member 34 will swing leftwards or rightwards. Meanwhile, the lateral wing structure 342A or 342B will touch and trigger the switch unit 36A or 36B. In addition, if the scroll wheel 32 is pressed down, the receptacle 351 of the supporting member 35 is served as the fulcrum portion such that the protrusion rod 343B is moved downwardly to trigger the switch unit 36C.

Please refer to FIG. 3A again. For a purpose of avoiding improperly swinging the carrier member 34 toward the left or right side or otherwise allowing for tiny swing of the carrier member 34 when the scroll wheel 32 is pressed down to trigger the switch unit 36C, the tiltable scroll wheel module 31 further comprises two confining members 37 and 38 for confining the carrier member 34 in position. The confining members 37 and 38 have complementary shapes. Due to the complementary shapes, the confining member 37 is shifted downwardly to be engaged with the confining member 38 while the scroll wheel 32 is pressed down to trigger the switch unit 36C. Therefore, the carrier member 34 is confined in position so as to avoid improperly swing the carrier member 34 toward the left or right side or otherwise allow for tiny swing of the carrier member 34. Under this circumstance, the lateral wing structure 342A or 342B will no longer trigger the switch unit 36A or 36B while the scroll wheel 32 is pressed down to trigger the switch unit 36C. Until the depressing force applied onto the scroll wheel 32 is eliminated, the scroll wheel 32 is moved upwardly and returns to its original shape due to a restoring force generated from the compressed spring 39. Meanwhile, the confining member 37 is disengaged from the confining member 38, so that the carrier member 34 can be tilted toward the left or right side as required.

Please refer to FIG. 3A again. In the tiltable scroll wheel module 31 of this embodiment, the confining member 37 is formed at the tip portion of the protrusion rod 343B and comprises a convex confining part 371. The confining member 38 has a concave confining part 381 corresponding to the convex confining part 371 of the confining member 37. The convex confining part 371 of the confining member 37 would be engaged with the concave confining part 381 while the scroll wheel 32 is pressed down to trigger the switch unit 36C. Therefore, the carrier member 34 is confined in position so as to avoid improperly swing the carrier member 34 toward the left or right side or otherwise allow for tiny swing of the carrier member 34. Under this circumstance, the lateral wing structure 342A or 342B will no longer trigger the switch unit 36A or 36B while the scroll wheel 32 is pressed down to trigger the switch unit 36C. Furthermore, a top cover 382 is extended from the confining member 238 and above the confining member 37. When the scroll wheel 32 is moved upwardly due to the restoring force generated from the compressed spring 39, the convex confining part 371 of the confining member 37 is stopped by the top cover 382 so as to prevent detachment of the confining member 37 from the confining member 38.

Please refer to FIG. 3B, which is a schematic rear view of FIG. 2A taken from a viewpoint in the direction RV3. As shown in FIG. 2B, in the case that the scroll wheel 32 is not enabled, the protrusion rod 343B of the carrier member 34 is slightly in contact with the top surface of the switch unit 36C but the switch unit 36C is not triggered. In addition, the convex confining part 371 of the confining member 37 is kept at least a certain clearance from the concave confining part 381 of the confining member 38. At that time, if the scroll wheel 32 is tilted toward the left side as shown in FIG. 3C, the convex confining part 371 of the confining member 37 is also tilted toward the left side along with the carrier member 34. Under this circumstance, the switch unit 36A is triggered by the carrier member 34 without being restricted by the confining member 38. Referring to FIG. 3D, the scroll wheel 32 is pressed down, and thus the switch unit 36C is triggered by the protrusion rod 343B of the carrier member 34. Since the convex confining part 371 of the confining member 37 is engaged with the concave confining part 381 of the confining member 38 at this moment, the carrier member 34 would not swing toward the left or right side or the swing of the carrier member 34 is not enough to trigger the switch unit 36C.

Please refer to FIG. 3A again. The convex confining part 371 of the confining member 37 and the concave confining part 381 of the confining member 38 have complementary shapes, so that the confining member 37 may be engaged with the confining member 38. It is noted that, however, those skilled in the art will readily observe that numerous modifications and alterations of the convex confining part 371 or the concave confining part 381 may be made while retaining the teachings of the invention. For example, as shown in FIGS. 3E and 3F, even though the convex confining part 371 and the concave confining part 381 are not completely mated with each other, the carrier member 34 could be confined in position to avoid improperly swinging the carrier member 34 toward the left or right side when the convex confining part 371 is engaged with the concave confining part 381. Accordingly, the above disclosure should be limited only by the bounds of the following claims.

Please refer to FIG. 3A again. The convex confining part 371 and the concave confining part 381 are formed at the confining members 37 and 38 of the carrier member, respectively. Alternatively, as shown in FIGS. 3G and 3H, a concave confining part 372 and a convex confining part 383 with complementary shapes are formed at the confining members 37 and 38 of the carrier member, respectively. When the concave confining part 372 is engaged with the convex confining part 383, the carrier member 34 could be confined in position to avoid improperly swing the carrier member 34 toward the left or right side.

Please refer to FIG. 3A again. In the tiltable scroll wheel module 31 of this embodiment, the confining member 37 is formed in the protrusion rod 343B of the carrier member 34. Alternatively, the confining member 37 is additionally arranged on the protrusion rod 343B of the carrier member 34, as is shown in FIG. 31.

Please refer to FIGS. 2A and 3A again. When the scroll wheel 22 or 32 of the tiltable scroll wheel module 21 or 31 is pressed down, the receptacle 251 or 351 of the supporting member 25 or 35 in front of the carrier member 24 or 34 is used as the fulcrum portion such that the carrier member 24 or 34 is moved downwardly to trigger the switch unit 26C or 36C. Alternatively, the supporting member 25 or 35 can be disposed behind the carrier member 24 or 34 but the switch unit 26C or 36C is disposed in the font of the carrier member 24 or 34. Likewise, when the scroll wheel 22 or 32 of the tiltable scroll wheel module 21 or 31 is pressed down, the receptacle 251 or 351 of the supporting member 25 or 35 behind the carrier member 24 or 34 is used as the fulcrum portion such that the carrier member 24 or 34 is moved downwardly to trigger the switch unit 26C or 36C

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input device comprising:
a main body having an opening in an outer surface thereof;
a scroll wheel disposed within said main body and partially protruded from said opening;
a carrier member for supporting said scroll wheel and permitting rotation of said scroll wheel thereon, wherein said carrier member includes a first confining member having a convex confining part;
a second confining member having a concave confining part below said convex confining part of said first confining member; and
a switch unit disposed below said carrier member, wherein said switch unit is triggered by said carrier member and said convex confining part of said first confining member is engaged with said concave confining part of said second confining member when said scroll wheel is pressed down, so that said carrier member is confined in position without largely swinging said carrier member toward the left or right side thereof.

2. The input device according to claim 1 wherein said second confining member further comprises a top cover arranged above said first confining member.

3. The input device according to claim 1 further comprising a spring sustained against said carrier member and said switch unit.

4. The input device according to claim 3 wherein said second confining member further comprises a top cover arranged above said first confining member.

5. The input device according to claim 1 wherein said convex confining part of said first confining member and said concave confining part of said second confining member have complementary shapes.

6. The input device according to claim 1 wherein said input device is a mouse.

7. An input device comprising:
a main body having an opening in an outer surface thereof;
a scroll wheel disposed within said main body and partially protruded from said opening;
a carrier member for supporting said scroll wheel and permitting rotation of said scroll wheel thereon, wherein said carrier member includes a first confining member having a concave confining part;
a second confining member having a convex confining part below said concave confining part of said first confining member; and
a switch unit disposed below said carrier member, wherein said switch unit is triggered by said carrier member and said concave confining part of said first confining member is engaged with said convex confining part of said second confining member when said scroll wheel is pressed down, so that said carrier member is confined in position without largely swinging said carrier member toward the left or right side thereof.

8. The input device according to claim 7 wherein said second confining member further comprises a top cover arranged above said first confining member.

9. The input device according to claim 7 further comprising a spring sustained against said carrier member and said switch unit.

10. The input device according to claim 9 wherein said second confining member further comprises a top cover arranged above said first confining member.

11. The input device according to claim 7 wherein said concave confining part of said first confining member and said convex confining part of said second confining member have complementary shapes.

12. The input device according to claim 7 wherein said input device is a mouse.
